(19) United States
(12) Patent Application Publication
(10) Pub. No.: US 2009/0098401 A1
(43) Pub. Date: Apr. 16, 2009

(54) Plastic optical fiber preform and production method thererof

(75) Inventors: Kosuke Yamaki, Shizuoka (JP); Yukio Shirokura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku (JP)

(21) Appl. No.: 11/919,755

(22) PCT Filed: May 22, 2006
(86) PCT No.: PCT/JP2006/310598

§ 371 Date: Nov. 1, 2007

(30) Foreign Application Priority Data
May 24, 2005 (JP) 2005-151393

(51) Int. Cl. G02B 6/028

(52) U.S. Cl. 428/542.8; 264/1.24

(57) ABSTRACT

A cylindrical preform (11) is drawn in its longitudinal direction to be a plastic optical fiber (21) by a drawing process (27). The preform (11) is produced by polymerizing an inner clad material in a hollow portion of an outer clad pipe (23) to form an inner clad (15), and then polymerizing a core material in a hollow portion of the inner clad (15) to form a core (12). After the polymerization of the inner clad material, the outer clad pipe (23) is subject to a heating under reduced pressure (25) to reduce penetration of the inner clad material into the outer clad pipe (23), such that a concentration of the inner clad material and its polymer penetrated in said outer shell is no more than 1.6 wt. %. Accordingly, an unevenness viscosity of the melted preform (11) for the drawing is reduced and the obtained plastic optical fiber (21) has an uniform transmission property.

### TECHNICAL FIELD

The present invention relates to a plastic optical fiber preform to obtain a plastic optical fiber by drawing, and relates to a production method of the plastic optical fiber preform.

### BACKGROUND ART

There is a plastic optical fiber having a cross section in which a refractive index increases toward the center in a stepwise manner or a continuous manner. Such plastic optical fiber is generally called “graded index plastic optical fiber”. For produce the graded index plastic optical fiber, there is a method in which a preform is formed by interface gel polymerization and then the preform is heat-drawn in its longitudinal direction to be the plastic optical fiber.

In the plastic optical fiber (hereinafter referred to as the POF) produced from the preform, there often is a change of the outer diameter in a short period, such as tens centimeters period. In the POF having the change of the outer diameter, a transmission loss is larger than that in the POF without the change of the outer diameter. Further, if the change of the outer diameter is periodical, there becomes problems such as that optical signals in specific wavelengths may be not able to be transmitted.

In considering these problems, there are many suggestions to reduce the change of the outer diameter of the POF. Japanese Patent Laid-Open Publication No. 11-337745 discloses a method in which a preform is drawn to be a POF by a drawing device having a low temperature heater under a heating furnace for melting the preform. In the low temperature heater, the heating temperature is controlled to be at least 50° C. lower than a glass transition point of the material of the preform. The Publication No. 11-337745 says that according to this method, the obtained POF of 750 μm outer diameter has a change of the outer diameter whose range is ±17 μm to ±21 μm. WO98/40768 discloses a method in which a reduction of pressure in a hollow portion of a preform and a melt viscosity of the preform are controlled in a predetermined range while melt-drawing the preform formed by polymerizing a core on an inner surface of a rotating clad material. WO98/40768 says that according to this method, an obtained POF has a change of the outer diameter whose range is ±5 μm. Japanese Patent Laid-Open Publication No. 8-337431 discloses a method in which a thermal insulation pipe is provided at downstream side along drawing direction from a heating furnace for melt-drawing so that a POF drawn out from the heating furnace does not contact the outside air. The Publication No. 8-337431 says that according to this method, application of unevenness cooling can be prevented on the obtained POF and the POF has a change of the outer diameter whose range is ±5 μm. Japanese Patent Laid-Open Publication No. 2001-124939 discloses a method in which residual monomer in a transparent polymer for a preform is reduced to 5 wt. % of the polymer. The Publication No. 2001-124939 says that according to this method, an obtained POF has a change of the outer diameter whose range is ±28 μm. As described above, there are two methods to reduce the change of the outer diameter, one is to control the drawing conditions, and the other is to reduce the residual monomer in the preform.

However, it was found that above two methods is not sufficient to reduce the change of the outer diameter. For example, the methods of WO98/40768 and Japanese Patent Laid-Open Publications No. 11-337745 and No. 8-337431 fail to realize the effect they state. A reason is, according to research of the inventor of the present invention, that when polymerizing the core monomer in the hollow portion of the clad to form the preform of the graded index POF, the core material penetrates into the inner wall of the clad and is solidified therein, and therefore unevenness of melt viscosity is caused around the inner wall of the clad material, which affects the uniformity of the outer diameter of the obtained POF. Japanese Patent Laid-Open Publication No. 2001-124939 also fails to efficiently reduce the change of the outer diameter, since the unevenness of melt viscosity is caused by the solidification of the core material penetrated into the clad, even if value of the residual monomer in the preform is limited.

An object of the present invention is to provide a production method of a preform for a plastic optical fiber, in which unevenness of melt viscosity around an inner wall of a clad of the preform is prevented from being caused in a drawing process, so that a plastic optical fiber formed by drawing the preform has an improved transmission property.

Another object of the present invention is to provide a plastic optical fiber having superior transmission property and a preform of the plastic optical fiber.

### DISCLOSURE OF INVENTION

In order to achieve the above objects and other objects, a production method for a plastic optical fiber preform according to the present invention comprises following steps. At first, a cylindrical member is formed. Then a polymerizable compound in a hollow portion of the cylindrical member is polymerized to form an inner member of polymer on an inner wall of the cylindrical member. The polymerization is bulk polymerization in which the polymerizable compound penetrates into the inner wall to generate and proceed polymerization reaction, and a concentration of the polymerizable compound and the polymer penetrated in the cylindrical member is controlled to a predetermined value.

It is preferable that a refractive index of the cylindrical member is no more than that of the polymer and the concentration is no more than 1.6 wt. %. It is preferable that the control of the concentration is performed while and/or after the polymerization reaction, by heating the cylindrical member in a reduced pressure. More preferably, the heating is performed in a temperature range of 40° C. to 130° C. It is preferable that the plastic optical fiber preform is a graded index plastic optical fiber preform, whose refractive index increases toward the center in the cross section.

A plastic optical fiber of the present invention comprises a cylindrical member and an inner member formed on an inner wall of the cylindrical member. The inner member is a polymer formed by bulk polymerization of polymerizable compound in a hollow portion of the cylindrical member, and a concentration of the polymerizable compound and the polymer penetrated in the cylindrical member is determined to a predetermined value. It is preferable that a refractive index of the cylindrical member is no more than that of the polymer, and the concentration is no more than 1.6 wt. %. The polymerizable compound is preferably (meth)acrylic acid ester, and the cylindrical member is preferably fluorine compound. The plastic optical fiber preform is preferably a graded index plastic optical fiber preform, whose refractive index increases toward the center in the cross section. In addition, the present invention includes a plastic optical fiber produced by drawing the plastic optical fiber preform described above in its longitudinal direction.

According to the present invention, the unevenness viscosity of the melted preform for the drawing is reduced, and thereby the plastic optical fiber, with superior transmission property by inhibiting the periodical change of the outer diameter thereof, can be produced.

### BRIEF DESCRIPTION OF DRAWINGS

FIG. 1 is a cross-sectional view of a preform of one embodiment of the present invention;

FIG. 2 is an explanatory view describing a refractive index distribution of the preform in the radius direction;

FIG. 3 is a process chart of a plastic optical fiber;

FIG. 4 is a schematic view of a melt-extrusion machine of outer die decompression absorption type;

FIG. 5 is a cross-sectional view showing an outline of one example of molding die;

FIG. 6 is a cross-sectional view showing an outline of a part of an inner sizing die type melt-extrusion machine;

FIG. 7 is a perspective view of a guide provided in the inner sizing die;

FIG. 8 is a cross-sectional view showing an outline of a polymerization container for rotation polymerization;

FIG. 9 is a perspective view of an outline of a rotation polymerization device;

FIG. 10 is an explanatory view describing the rotation of the polymerization container in the rotation polymerization device; and

FIG. 11 is a schematic view of a drawing apparatus.

### BEST MODE FOR CARRYING OUT THE INVENTION

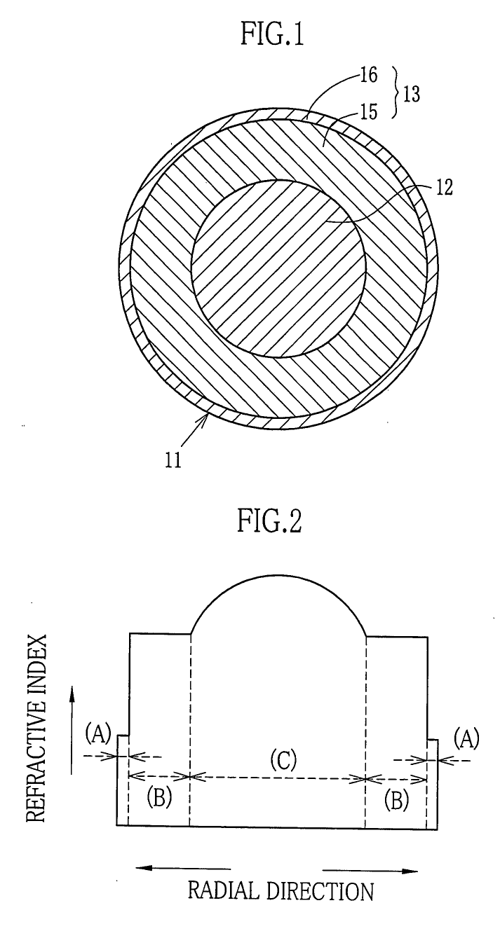

The preferable embodiments of the present invention are hereinafter described, but these embodiments do not limit the present invention. In the present invention, a preform is firstly formed, and then the preform is drawn in its longitudinal direction to form a plastic optical fiber (hereinafter POF). At first, a structure, components and refractive index of the preform will be described with reference to FIG. 1 and FIG. 2. A manufacture method of the POF will be described later.

As shown in FIG. 1, the preform 11 has the core 12 for transmitting optical signal, and a clad 13 as an outer shell. The clad 13 comprises an inner clad 15 contacting to the outer periphery of the core 15, and an outer clad 16 around the outer periphery of the inner clad 15. Accordingly, the outer diameter of the inner clad 15 equals to the inner diameter of the outer clad 16, and the diameter of the core 12 equals to the inner diameter of the inner clad 15.

The outer clad 16 has a tubular shape with the thickness, the outer diameter and the inner diameter which are uniform in the longitudinal direction. The outer clad 16 is formed from polyvinylidene fluoride (PVDF), for example, by melt-extrusion. However, the outer clad 16 may be formed from polymethylmethacrylate (PMMA) or other materials, which will be explained later. The inner clad 15 has a tubular shape with the thickness, the outer diameter and the inner diameter which are uniform in the longitudinal direction, as same as the outer clad 16. The inner clad 15 is formed from PMMA. The outer clad 16 and the inner clad 15 may be simultaneously formed by melt-extrusion. The outer clad 16 and the inner clad 15 may be successively formed by melt-extrusion of the outer clad 16, pouring polymerizable compound like methylmethacrylate (MMA) in the outer clad 16, rotating the outer clad 16 and polymerizing the compound to form the inner clad 15 inside the outer clad 16.

In FIG. 2, the horizontal axis indicates the distance from the center of the preform 11 in the radial direction, and the vertical axis indicates the refractive index. The refractive index increases as the line in the graph goes upward. The range (A) corresponds to the outer clad 16, the range (B) corresponds to the inner clad 15, and the range (C) corresponds the core 12.

As shown in FIG. 2, in the core 12, the refractive index continuously increases from the boundary with the inner clad 15 to the center. The refractive index in the outer clad 16 is smaller than that in the inner clad 15, and the refractive index in the inner clad 15 is smaller than that in the core 12. In order to provide such refractive index profile in the core 12, the core 12 is preferably formed by interface gel polymerization that will be described later. It is preferable that the difference between the maximum value and the minimum value of the refractive index is in a range of 0.001 to 0.3 through the radius direction of the preform 11. Under this structure, the preform 11 itself exhibits the function as the light transmission medium, before being drawn to be the POF. Although the preform 11 in FIG. 1 clearly shows a border between the inner clad 15 and the core 12 for convenience of the explanation, the border may be identified not clearly, because the clarity of the border is dependent on conditions of the production.

The inner clad 15 of this embodiment has approximately constant refractive index as shown in FIG. 2. However, the refractive index may increase toward the core 12, both in a stepwise manner or a continuous manner.

In the present invention, the core 12 and the inner clad 15 may have other structure than the above. For example, there is no border between the inner clad 15 and the core 12 and the refractive index increases in the stepwise or continuous manner from the inner periphery of the outer clad 16 toward the center of the core 12, or the core 12 has plural layers. Although the outer clad 16 has a single layer in this embodiment, it may have two or more layers. In addition, the core 12 may have a tubular shape including a hollow portion. These structures and other structures are designed according to conditions of the production. Note that in the preform 11 and the POF from the preform 11, a light entered from the end surface may be reflected at the inner periphery of the inner clad 15 and pass through only within the core 12, or reflected at the inner periphery of the outer clad 16 and pass through both within the inner clad 15 and the core 12.

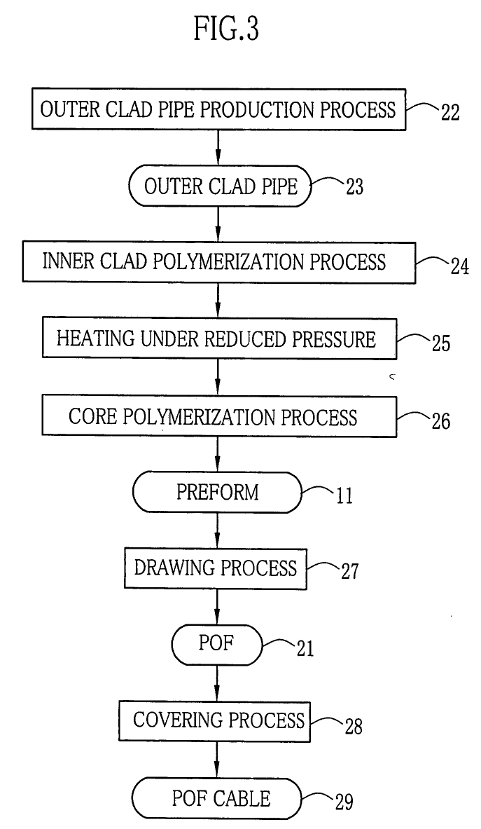

Next, the manufacture method of the preform 11 and a POF cable will be described with reference to FIG. 3. The manufacture processes are described roughly in the following paragraphs, and the details of each process will be described later. The POF 21 is obtained by drawing the preform 11 in the longitudinal direction. Accordingly, the POF 21 has the same basic structure as the preform 11, although the diameter thereof is smaller than that of the preform 11. The POF 21 has a clad and a core, and the clad includes an outer clad and an inner clad. That is, the core and the clad of the preform 11 become the core and the clad of the POF 21 by drawing.

In the outer clad production process 22, a pipe 23 is produced as an outer clad of the preform 11. Since the outer clad is the outer shell of the preform 11 as stated above, the outer clad pipe 23 is circular pipe. In the hollow portion of the pipe 23, material for an inner clad is poured. In the inner clad polymerization process 24, the tubular inner clad is formed on the inner peripheral surface of the outer clad pipe 23. In the heating under reduced pressure 25, the outer clad pipe 23 with the inner clad is heated under reduced pressure. The heating under reduced pressure 25 may be performed while polymerizing the material for the inner clad, in addition to or instead of after the inner clad polymerization process 24. Since the heating under reduced pressure 25 is applied, unevenness viscosity of the melted preform 11 for the drawing is reduced.

In the core polymerization process 26, a core is formed in the hollow portion of the inner clad. Accordingly the preform 11 is obtained. In the drawing process 27, the preform 11 is drawn in the longitudinal direction to become the POF 21. Since the covering process 28 is applied to the POF 21, the POF 21 becomes the POF cable 29 with its outer peripheral surface being covered by a covering material.

Hereinafter, the manufacture method for the POF 21 will be explained in detail. The outer clad pipe 23 may be obtained from the polymer formed to tubular shape by melt-extrusion, or by rotation polymerization in which the polymer is shaped while polymerization reaction of polymerizable compound. In this embodiment, PVDF is used as the polymer for the outer clad (hereinafter the outer clad polymer), and is melt-extruded to form the outer clad. To perform the melt-extrusion, a commercial type screw-extrusion machine may be used. As the screw-extrusion machine, there are two types both of which can be used, the inner sizing die type and the outer die decompression absorption type.

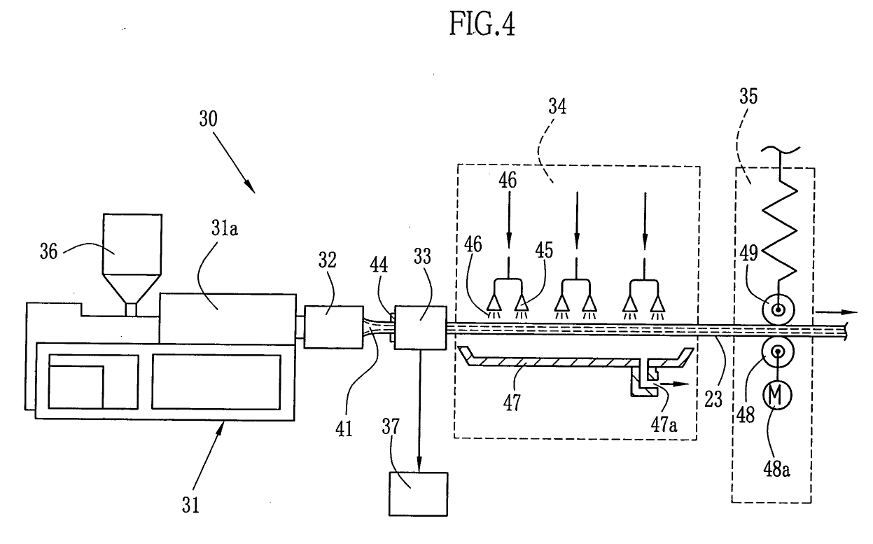

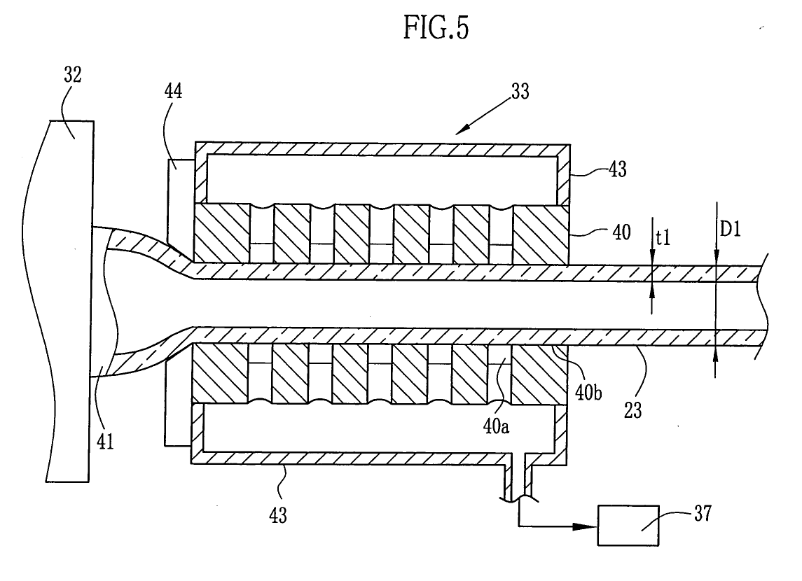

At first, the outer die decompression absorption type is described. Referring to FIG. 4, a melt-forming apparatus 30 comprises a melt-extrusion device 31, an extrusion die 32, a molding die 33, a cooler device 34 and a drawing machine 35. To the melt-extrusion device 31, a pellet casting hopper 36, for supplying raw polymer into the melt-extrusion device 31, is attached. And a melting section 31a, for melting the raw polymer, is provided in the melt-extrusion device 31. The molding die 33 is connected with a vacuum pump 37. In addition, as shown in FIG. 5, the molding die 43 has a molding pipe 40 in which there are plural suction holes 40a, through which inside the molding pipe is decompressed. The suction holes 40a are connected to a decompression chamber 43 provided outside of the molding pipe 40.

To the cooling device 34, a plurality of nozzles 45 is provided for spraying cooling water 46. A water receiver 47 is provided downward for collecting the cooling water 46. The winding machine 35 comprises a drive roller 48 and a pressure roller 49. The winding speed by the drawing machine 35 is controlled by a motor 48a that is connected to the drive roller 48.

Raw polymer 41 supplied from the hopper 36 is melted in the melting section 31a, and is extruded by the extrusion die 32 for supplying to the molding die 33. The extrusion speed S (m/min) is preferably 0.1 (m/min) to 10 (m/min), more preferably 0.3 (m/min) to 5.0 (m/min), and most preferably 0.4 (m/min) to 1.0 (m/min). However, the extrusion speed S (m/min) is not limited to the preferable range mentioned above.

The raw polymer 41 passes through the molding pipe 40 to be shaped to form the cylindrical outer clad pipe 23. When the decompression chamber 43 is decompressed by the vacuum pump 37, the outer wall of the pipe 23 comes in close contact with the molding surface (inner surface) of the molding pipe 40, so the thickness of the pipe 23 becomes uniform. The pressure in the decompression chamber 43 (absolute pressure) is preferably 20 kPa to 50 kPa, but not limited to this range. In order to regulate the diameter of the pipe 23, a throat member (diameter regulation member) 44 is preferably fixed at the entrance of the molding die 33.

The pipe 23 shaped by the molding die 33 is fed to the cooling device 34. In the cooling device 34, the cooling water 46 is sprayed from the nozzles 45 toward the pipe 23. Thereby, the pipe 23 is cooled and becomes solidified. The sprayed cooling water 46 is collected in the water receiver 47, and then ejected through a drain opening 47a. The pipe 23 is drawn from the cooling device 34 by the drawing machine 35. The pipe 23 is sandwiched between the drive roller 48 and the pressure roller 49. The feeding speed of the pipe 23 can be adjusted by the drive roller 48 and the feeding position of the pipe 23 can be adjusted by the pressure roller 49. Thereby, it is possible to keep the uniform shape (especially the uniform thickness) of the pipe 23. If necessary, the drive roller 48 and the pressure roller 49 may be belt-shaped.

The pipe 23 may be composed of plural layers for the purpose of providing functions such as the mechanical strength and incombustibility. In addition, after the hollow cylindrical pipe having the arithmetic average roughness of a certain range is formed, the outer surface of the cylindrical pipe may be coated with fluorine resin or the like.

The outer diameter D1 (mm) of the pipe 23, which corresponds to the outer diameter of the preform 11, is preferably 20 mm to 50 mm, in consideration of the optical property and the productivity. More preferably, the diameter D1 is 2 mm to 32 mm. Although the thickness t1, (mm) of the pipe 23 can be small as long as the pipe 23 can keep its shape, the thickness t1 is preferably 0.5 mm to 3 mm. Note that these numerical ranges of the outer diameter D1 and the thickness t1 do not limit the present invention.

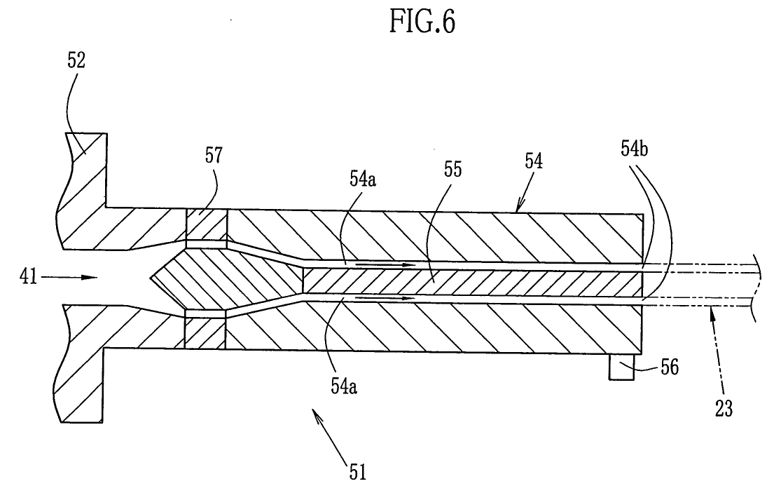

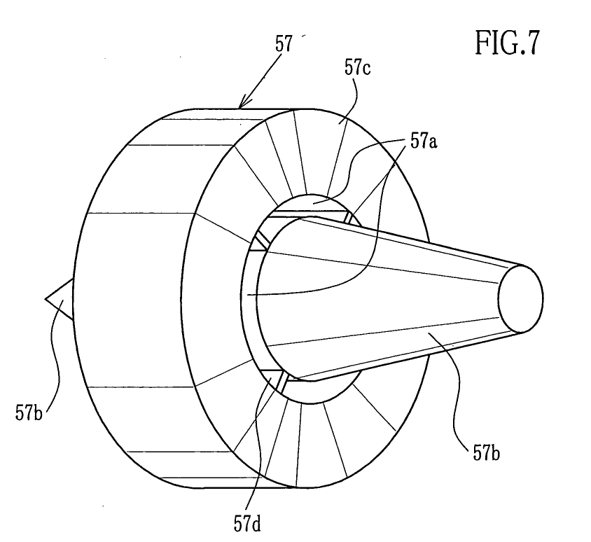

Referring to FIG. 6 and FIG. 7, the inner sizing die type is described. In FIG. 6, the raw polymer and the outer clad pipe are applied with same numerals as FIG. 4 and FIG. 5. An extrusion molding machine 51 of the inner sizing die type comprises a main body 52 and a die 54. An inner rod 55 is provided inside the die 54. The inner rod 55 forms a flowing passage 54a for the raw polymer 41 inside the die 54, and a guide 57 for guiding the raw polymer 41 toward the flowing passage 54a is provided between the main body 52 and the die 54. As shown in FIG. 7, the guide 57 has a guiding passage 57a for guiding the polymer toward the flowing passage 54a. The guiding passage 57a is formed by an shaft 57b connected to the inner rod 55, a main section 57c for regulating the flow of the polymer, and supports 57d for supporting the shaft 57b to the main section 57c. The PVDF, which is the raw polymer 41 in this embodiment, is extruded by a single screw extruder (not illustrated) from the main body 52 to the die 54. The raw polymer 41 passes the flowing passage 54a between the die 54 and the inner rod 55. Then the raw polymer 41 is extruded from an outlet 54b of the die 54 so that the cylindrical pipe 23 is formed. Although there is no limitation in the extrusion speed of the pipe 23, it is preferably 1 cm/min to 200 cm/min, in terms of productivity and the uniformity of the pipe 23.

The die 54 preferably comprises a heater for heating the raw polymer 41. For instance, one or more heater (for instance, heat generating device by use of steam, thermal oil and an electric heater) are provided along the flowing passage 54a so as to cover the die 54. In this embodiment, a thermometer 56 is provided in the vicinity of the outlet 54b of the die 54. In order to control the heating temperature, the thermometer 56 measures the temperature of the pipe 23 near the outlet 54b.

The heating temperature is dependent on the kind of the raw polymer 41, and preferably is no less than the glass transition temperature, so that the shape of the pipe 23 is kept uniform. The temperature of the pipe 23 is preferably 40° C. or higher because of reducing the change of the shape by rapid temperature change. The temperature of the pipe 23 may be controlled by a cooler device (for example, it utilizes liquid like water, an anti-freezing solution and oil, and an electric cooling) that is fixed to the die 54. The pipe 23 may be cooled by natural cooling. When the heater device is also provided with the die 54, the cooler device is preferably provided in the downstream side of the heater device with respect to the flow direction of the raw polymer 41.

When the pipe 23 is formed, there becomes a difference in the form of the crystal of the PVDF according to a difference of the lip clearance of the die 54. Form II crystal having superior solvent resistance is generally generated by cooling the molten PVDF. Form I crystal having inferior solvent resistance is generated by drawing the molten PVDF at relatively low temperature. When the lip clearance becomes wider, the cooling speed of the PVDF becomes slower which increases the drawing temperature. Accordingly, the ratio of the form II crystal in the polymer is increased, and the polymerizable compound for the inner clad is hard to penetrate into the pipe 23 in the inner clad polymerization process. On the other hand, when the lip clearance is narrower, a spherocrystal size becomes smaller because the shear speed becomes faster. Accordingly, inside surface roughness is improved. For balancing these conditions, the lip clearance is preferably in a range of 1 mm to 7 mm, more preferably in a range of 2 mm to 6 mm, most preferably in a range of 2.5 mm to 4.5 mm. When the lip clearance is below 1 mm, the formed outer clad pipe 23 contains too large ratio of the form I crystal. Accordingly, the polymerizable compound for the inner clad penetrates into the pipe 23, and fluctuation in the outer diameter of the POF possibly becomes large. When the lip clearance is over 7 mm, the spherocrystal size becomes too large because the cooling speed becomes too slow, and thereby the inside surface roughness possibly becomes worse. As stated above, if the lip clearance is not correctly determined, the transmission loss possibly increases.

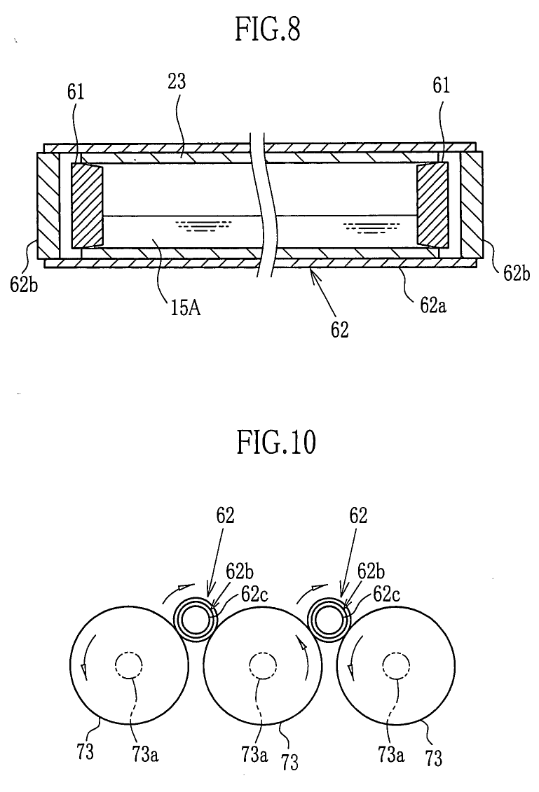

The forming methods of the inner clad and the core are described with reference to FIGS. 8 to 10. A polymerization apparatus and a polymerization container shown in FIGS. 8 to 10 do not limit the scope of the present invention, and the embodiment is an example of the present invention.

The pipe 23 is cut to be 600 mm to 1500 mm length. One end of the pipe 23 is sealed with a plug 61 formed from a material that is not dissolved by the polymerizable compound for the inner clad and the core. An example of the material of the plug 61 is polytetrafluoroethylene (PTFE). The plug 61 does not contain the compound that flows out a plasticizer. After sealing the end of the pipe 23, an inner clad monomer 15A is poured in the hollow portion of the pipe 23. The other end of the pipe is sealed with the plug 61, and then the inner clad 15 (see FIG. 1) is formed by the rotation polymerization. In the polymerization of the inner clad monomer, the pipe 23 is kept in a polymerization container 62 that comprises a cylindrical chamber body 62a and a pair of lids 62b for sealing both ends of the chamber body 62a. The chamber body 62a and the lids 62b are made of SUS. As shown in FIG. 8, the inner diameter of the polymerization container 62 is slightly larger than the outer diameter of the pipe 23, and the rotation of the pipe 23 is synchronized with the rotation of the polymerization container 62. In order to ensure to rotate the pipe 23 together with the polymerization container 62, a support member or the like may be provided in the inner wall of the polymerization container 62.

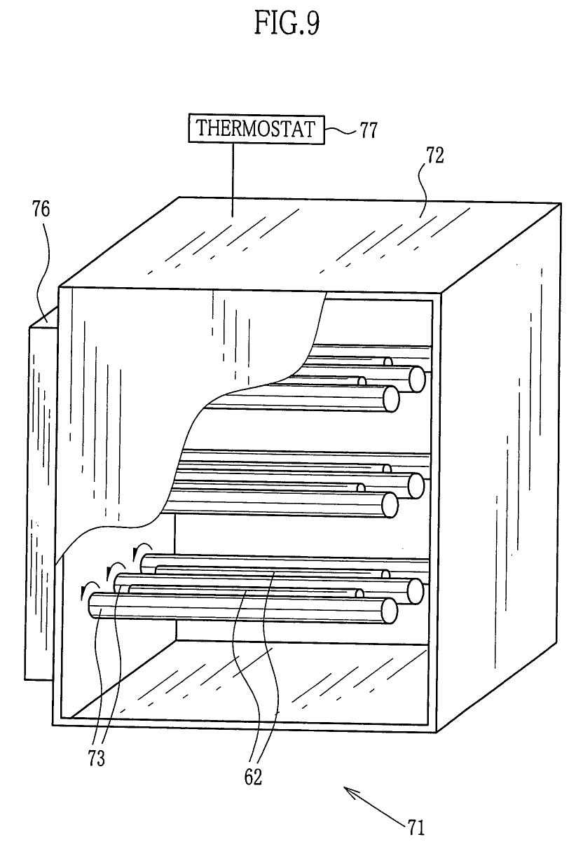

As shown in FIG. 9, a rotation polymerization device 71 comprises plural rotation members 73, a motor 76 and a thermostat 77. The rotation members 73 are in a housing 72, and the motor 76 and the thermostat 77 are provided outside of the housing 72. The thermostat 77 measures the temperature in the housing 72, and controls this temperature based on the measured result.

The cylindrical rotation members 73 are arranged in parallel such that the polymerization container 62 is supported by adjacent two rotation members 73. One end of the rotation member 73 is rotatably supported by the inner wall of the housing 72, and independently driven by the motor 76. The motor 76 has a controller (not illustrated) for controlling the operation of the motor 76. In the polymerization, the polymerization container 62 is held in the space between the surfaces of the adjacent rotation members 73, and rotated in accordance with the rotation of the rotation members 73 around the rotational axis 73a, as shown in FIG. 10. The method to rotate the polymerization container 62 is not limited to the surface drive type described in this embodiment.

In addition, upper rotation members may be provided above the polymerization container 62, and the upper rotation members may be rotated together with the rotation members 73 to prevent the polymerization container 62 from moving upward. It is also possible to provide holding means above the polymerization container 62 to apply certain weight to the polymerization container 62, but the method to hold the polymerization container 62 does not limit the scope of the present invention.

Next, the inner clad polymerization process 24 is described. The inner clad material including the inner clad monomer will be explained later. The inner clad 15 between the core 12 and the outer clad 16 affects the polymerization of the core monomer. Note that the inner clad 15 may be not needed in some conditions for polymerization of the core, and there may be a case that the inner clad is unified with the core in the core polymerization process and disappeared as the inner clad. The inner clad material such as the inner clad monomers is preferably used after removing inhibitor, moisture, impurities and so forth, by filtering and distillation. In addition, it is preferable that the mixture of the inner clad monomer and the polymerization initiator is subject to ultrasonic wave process to remove dissolved gas and volatile component. After pouring the inner clad material, the ends of the pipe 23 are sealed with plugs. Note that the heating under reduced pressure 25 (see FIG. 3) may be performed while or after the pouring, when the polymerization is not completed. In this case, it is preferable that data of the manner of the polymerization from the pouring to the completion of the polymerization is previously obtained, so that the timing for performing the heating under reduced pressure 25 is determined based on the obtained data.

Thereafter, the polymerization container 62 containing the pipe 23 is rotated with its longitudinal direction being kept substantially horizontally. The inner clad 15 is formed and the pipe 23 becomes the outer clad 16 by the polymerization of the inner clad material while the polymerization container 62 is rotated. In this way, the inner clad 15 is formed by the rotation polymerization in which the pipe 23 is rotated around its cylinder axis while the polymerization. Before the rotation polymerization, the inner clad material may be subject to preliminary polymerization in which the pipe 23 is kept substantially vertically.

The polymerization temperature of the inner clad monomer is preferably in a range of 60° C. to 90° C. The speed of the horizontal rotation is preferably in a range of 500 rpm to 3000 rpm. The thickness of the inner clad 15 is preferably in a range of 0.05×D1 to 0.3×D1.

The inner clad material comprises the inner clad monomer and polymerization initiator (reaction initiator) in the present invention. In addition, the inner clad material may contain chain transfer agent (molecular amount control agent).

In this embodiment, the inner clad monomer is methylmethacrylate (MMA). However, another polymerizable compound can be used as the inner clad monomer. Examples of the preferable inner clad monomer will be described later.

After the above processes, the clad 13 is taken out from the rotation polymerization device 71. Then the clad 13 is subject to the heating under reduced pressure 25. According to this process, the core material is prevented from penetrating into the clad 13, so that the unevenness viscosity of the melted preform 11 for the drawing is reduced.

The heating under reduced pressure is effective to reduce the unevenness viscosity of the melted preform for the drawing, when the preform is the refractive index distribution type in which the inner clad or the core is formed by the polymerization, not by co-extrusion molding. That is, this process is effective in a case that the inner clad material penetrates into the outer clad, or the core material penetrates into the clad, and then the polymerization reaction is progressed. A known decompression heater such as a decompression temperature controller can be used for the heating under reduced pressure. Since the heating under reduced pressure is performed, the penetration of the inner clad material or a part of polymer such as an oligomer into the outer clad pipe is inhibited. Therefore the unevenness viscosity of the melted preform for the drawing is reduced. In addition, the production loss of the POF is significantly reduced, and the POF having uniform property can be obtained.

The penetration is preferably regulated such that a rate of content of the inner clad material and its polymer in the outer clad is no more than 1.6 wt. %. When the rate is over 1.6 wt. %, the unevenness viscosity of the melted preform for the drawing becomes large and it is possible to occur a periodical change of the outer diameter. Note that the rate of content is measured in an area of the outer clad where the inner clad material and its polymer penetrate.

The temperature in the heating under reduced pressure 25 is preferably in a range of 40° C. to 130° C., more preferably in a range of 50° C. to 130° C., most preferably in a range of 60° C. to 120° C. However, the preferable temperature is determined according to the material of the outer clad pipe, and is not limited to the above range. To determine the preferable heating temperature, the glass transition point, the thermal deformation point, the melting point and so forth may be in consideration. When the temperature is too high, it is possible that there becomes deformation of the preform, or movement of the dopant in the preform which causes a distortion of the refractive index distribution. In addition, when the heating under reduced pressure is performed while the polymerization progresses, the heating temperature is needed to be controlled not to interfere the polymerization reaction, by considering the boiling point of the material for the polymerization and the effective temperature range of the polymerization initiator and so on.

The pressure in the heating under reduced pressure 25 is preferably as low as possible. For example, the pressure for heating the preform of PMMA or PVDF is preferably no more than 50 Pa, more preferably no more than 10 Pa, and most preferably no more than 5 Pa. In the lower pressure, the penetration of the inner clad material into the outer clad pipe can be prevented at lower temperature than in the higher pressure. When the pressure is more than 50 Pa, the above described effects are hardly expected.

The period for the heating under reduced pressure is preferably in a range of 5 hours to 24 hours, more preferably in a range of 8 hours to 20 hours, and most preferably in a range of 10 hours to 18 hours. Although the effect of the prevention of the penetration is increased according to lengthening the period for the heating till the period reaches 30 hours, the effect becomes hardly increased even if the heating is performed any longer period than 30 hours.

A rate of content of the core material and its polymer in the clad is preferably no more than 1.6 wt. %. When the rate is over 1.6 wt. %, it is possible that a change of the outer diameter of the POF obtained by the drawing becomes large.

Next, the core monomer is poured into the hollow portion of the inner clad. When MMA is used as the core monomer, the polymerization initiator, the chain transfer agent and the refractive index control agent (dopant) and the like (if needed) are preferably poured with the core monomer. These additives are for example mixed with the core monomer at first and then the mixture is poured into the hollow portion of the inner clad after filtration. As described, it is preferable that the filtration is applied to the monomer before the pouring. The filter preferably has a performance of trapping particles of approximately 0.2 μm diameter. Each amount of the polymerization initiator, the chain transfer agent and the dopant are described later. The refractive index along the radius direction of the core 12 (see FIG. 1) may be changed by using at least two kinds of the core monomer, instead of by using the dopant. In this embodiment, as the dopant, a low molecular compound, which has high refractive index and large volume of molecule and is not related to the polymerization, is used to change the refractive index along the radius direction of the core.

In this embodiment, the polymerization of the core monomer is performed by rotation gel polymerization. In this method, the ends of the tubular clad 13 are sealed with the plugs 61 after the core monomer, the polymerization initiator, the dopant and so forth are poured into the hollow portion of the clad 13. Then the clad 13 is contained again in the polymerization container 62, to be horizontally rotated for proceeding the polymerization reaction as same as the forming of the inner clad. When the core monomer starts the polymerization, the core monomer swells the inner wall of the inner clad 15 to generate a gelled swelled layer in an initial stage of polymerization. Such swelled layer accelerates the polymerization of the core monomer (gel effect). That is, the reaction is the bulk polymerization. The polymerization of the core monomer proceeds from the inner wall of the inner clad 15 toward the center of the cross section of the clad 13. In the polymerization, the compound having smaller molecular volume tends to move to the swelled layer, so the dopant having relatively large molecular volume tends to move from the swelled layer side to the center of the clad. As a result, the concentration of the dopant having high refractive index increases in the center of the core, and the preform 11 has the refractive index profile in which the refractive index increases from the inner clad side toward the center of the core 12.

In this embodiment, since both the inner clad and the core are made of PMMA and the preform 11 is formed by generating the swelled layer, the preform 11 does not have a clear border between the inner clad 15 and the core 12. The clearness of the border changes in accordance with the affinity of the inner clad 15 to the core 12, the manufacture condition like generation of the swelled layer, and so forth. It is preferable that the outer diameter of the core 12 is in a range of 0.73×D1 to 0.97×D1.

The polymerization of the core monomer is preferably performed with heating. The heating temperature is determined according to the kind and other conditions of the core monomer and the polymerization initiator. Especially, polymerization speed and alteration temperature are needed to be considered. For example, when a typical methacrylic low molecular compound is used as the main content of the core monomer, the heating temperature is preferably in a range of 50° C. to 150° C., more preferably in a range of 60° C. to 140° C., and most preferably in a range of 80° C. to 120° C. According to the heating in the preferable heating temperature, the core having small optical loss can be formed. The polymerization period is also determined according to the kind of the core monomer and other conditions. It is preferable that the period is in a range of 4 hours to 72 hours. The speed of the horizontal rotation is preferably in a range of 500 rpm to 3000 rpm. According to this preferable rotation speed, suitable centrifugal force can be generated for forming the core having the uniform diameter.

After the heating polymerization is performed with applying pressure, heat treatment is applied to proceed and complete the polymerization. In this specification, each polymerizable compound for the inner or and the core is respectively called as the inner clad monomer or the core monomer. However, the compound is not required to be the monomer. It may be dimer or trimer. In addition, the present invention does not depend on the forming method for the preform.

After forming the core, it is preferable that the heating under reduced pressure is performed as same as after forming the inner clad. The heating under reduced pressure may be performed while forming the core, in addition to or instead of after forming the core. Since the heating under reduced pressure is performed, the penetration of the core material or a part of polymer such as an oligomer into the inner clad is inhibited. As described above, when the preform has plural layers, the heating under reduced pressure may be applied respectively to each of the layers.

Next, the preform 11 is drawn to be the POF 21. Note that the present invention does not depend on a drawing method and a drawing apparatus, and any known methods and apparatuses may be used for the drawing.

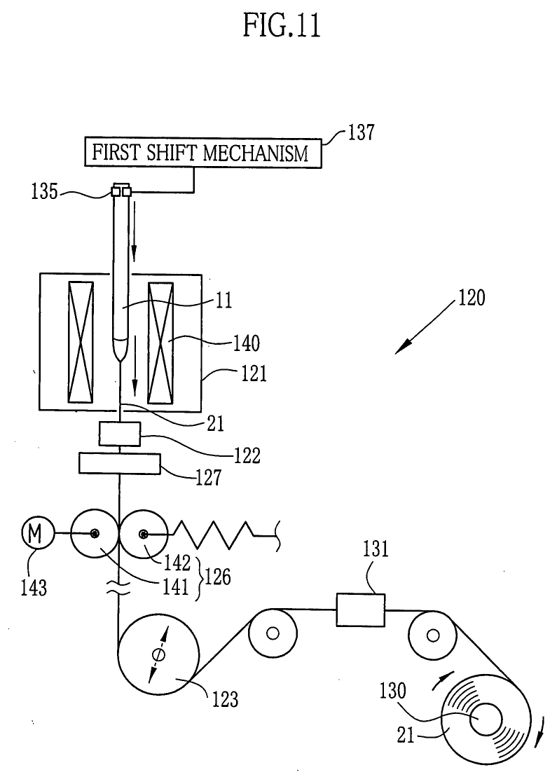

As shown in FIG. 11, the drawing apparatus 120 comprises a heater 121 for heating the preform 11, a drawing tension measure device 122 for measuring the tension of drawing the heated preform 11, a dancer roller 123 for adjusting the tension of the drawing based on the measuring result from the drawing tension measure device 122, a drawing roller pair 126 for adjusting the drawing speed, a diameter measure device 127 for measuring the diameter of the POF 21 formed by the drawing, a winding device 130 for winding the POF 21, and a winding tension measure device 131 for measuring the tension (winding tension) to the POF 21 in the winding.

In upstream side from the heater 121, there are a holder 135 for moving the held preform 11 downward, and a first shift mechanism 137 for controlling the holder 135 to hold, release or move the preform 11.

In the heater 121, a hollow cylindrical heating furnace 140 is provided. The heating furnace 140 can change the heating temperature along the drawing direction of the preform 11. The drawing roller pair 126 comprises a drive roller 141 and a pressure roller 142 between which the POF 21 is drawn downward. The drive roller 141 is connected to a motor 143 that can control the rotation speed of the drive roller 141. The dancer roller 123 has a second shift mechanism (not shown) for changing the position of the dancer roller 123 to adjust the tension of the drawing. In addition, the tension of the drawing can be adjusted by the speed of moving the preform 11 downward, the rotation speed of the drive roller 141 or the heating temperature in the heating furnace 140.

The preform 11 is drawn with its upper portion being held by the holder 135. The holder 135 holding the preform 11 is moved downward according to the drawing speed. When most part of the preform 11 is drawn and the holder 135 reaches a predetermined position, the first shift mechanism detects it and controls the holder 135 to release the preform 11.

The preform 11 held by the holder 135 is guided inside the heating furnace 140, drawn and moved downward according to the drawing speed. Note that the first shift mechanism 137 has an alignment device (not shown) for adjust the center position of the cross-section circle of the preform 11 with accuracy. Accordingly, the excellent line shape and cross-section roundness of the POF 21 can be obtained.

A gas supply device (not shown) is preferably provided to supply inert gas to set the heater device 121 in an inert gas atmosphere, so as not to deteriorate the preform 11 by the heat melting. Examples of the inert gas are nitrogen gas, helium gas, neon gas and argon gas. In terms of the manufacture cost, nitrogen gas is preferable. Helium gas is preferable in terms of thermal conductivity. A mixture gas, such as a mixture gas of helium and argon, may be also used.

The preform 11 in the heating furnace 140 is melted little by little from the lower end thereof, and then drawing the molten preform can manufacture the POF 21. The heating temperature is preferably in a range of 180° C. to 250° C. in general, although it may be take any value according to the material of the preform 11 or other conditions. The drawing condition (such as the drawing temperature) can be determined in accordance with the materials and the diameters of the preform 11, and the diameter of the POF 21. In forming the GI type POF having the refractive index profile in the core, it is necessary to carry out the heating and drawing evenly in the radial direction of the POF, in order not to destroy the refractive index profile. Thus, the cylindrical heater capable of heating the preform 11 uniformly over the cross section thereof is preferably used.

The heating chamber 140 preferably has a distribution in the temperature in the drawing direction of the preform 11. According to that, melting period of each part of the preform 11 can become shorter, and melting area of the preform 11 at one point in time can become shorter. When the melting area becomes longer in the drawing direction, the melting period of each part of the preform 11 becomes longer, which causes a fluidization of the content molecules in the preform 11 and destroys the refractive index profile in the radius direction. Therefore, it is preferable to carry out preheat process at the position before the heating area, and to carry out cooling process at the position after the heating area. Note that the cooling process may be the natural cooling. The heating device for the melting process may be a laser device that can supply high energy in a small area.

The drawing tension measure device 122 measures the drawing tension to the POF 21. The diameter measure device 127 measures the diameter of the POF 21. The POF 21 is drawn by the drawing roller pair 126 at a desirable drawing speed (2 m/min to 50 m/min, for example). The drawing speed is controlled by the motor 143 which controls the rotation speed of the drive roller 141. The moving speed of the holder 135, the heating temperature of the heating furnace 140, drawing speed by the drawing roller pair 126 and so forth, are controlled such that the POF 21 has a predetermined diameter.

As described in JP-A No. 7-234322, the tension in the drawing process (drawing tension) is preferably 0.098 N or more. In order not to leave distortion in the POF 21 after the melt-drawing process, the drawing tension is preferably 0.98 N or less, as described in JP-A No. 7-234324. Since the drawing tension changes in accordance with the diameter and the material for the POF, the drawing tension is needed to be adjusted according to the above conditions. It is possible to carry out preliminary heating process in the melt-drawing, as described in JP-A No. 8-106015.

The POF 21 is fed downward by the dancer roller 123 for adjusting the tension to the POF 21. The dancer roller 123 is connected to a drive unit (not shown) for changing the position of the dancer roller 123. Thereafter, the POF 21 is fed by a roller to the winding tension measure device 131 for measuring the tension (winding tension) to the POF 21. The POF 21 through the winding tension measure device 131 is fed by a roller to the winding device 130. When the winding device 130 is rotated by a rotation drive unit (not illustrated), the POF 21 is wound around the winding device 130. Based on the measured value of the winding tension by the winding tension measure device 131, the winding tension is appropriately adjusted. The adjustment can be performed by changing the rotation speed of the winding device 130.

The bending and lateral pressure properties of the POF improve by setting the elongation break and the hardness of the manufactured POF, as described in JP-A No. 7-244220. Moreover, as described in JP-A No. 8-54521, the transmission property of the POF improves by providing a low refractive index layer as the reflection layer around the POF. According to controlling the above described drawing conditions properly, the orientation of the polymer which forms the POF can be controlled, to obtain desired properties of the POF, such as mechanical property (for example the flexibility), heat shrinkability and so forth.

The clad and core material for the preform is not limited as long as having the optical transmission function. The preferable material is organic material with high optical transparency. For completely reflecting the signal light at the interface between the core and the outer clad, the outer clad material needs to be a polymer having a smaller refractive index than the inner core material. Moreover, the inner clad material and the core material are preferably a polymer which is amorphous to prevent light scattering and has excellent fitness to each other, excellent toughness, moisture resistance and heat-resistance. It is also preferable to protect the core from moisture. Thus, a polymer with low water absorption is used as the clad material, especially as the outer clad material. The outer clad may be formed from the polymer having the saturated water absorption (water absorption) of less than 1.8%. More preferably, the water absorption of the polymer is less than 1.5%, and most preferably less than 1.0%. The water absorption (%) is obtained by measuring the water absorption after soaking the sample of the polymer in the water of 23° C. for one week, pursuant to the ASTM D 570 experiment.

Examples of the polymerizable compounds for the core and the inner clad are (meth)acrylic acid esters [(a) (meth)acrylic ester without fluorine, (b) (meta)acrylic ester containing fluorine], (c) styrene type compounds, (d) vinyl esters, bisphenol-A as the raw material of polycarbonate, and the like. As the clad forming polymer, vinylidene fluoride (PVDF) is also preferable. In addition, homopolymer composed of one of these monomers, copolymer composed of at least two kinds of these monomers, or a mixture of the homopolymer(s) and/or the copolymer(s) may be used as the polymerizable compound. When the mixture of polymers is used, the boiling point Tb thereof is defined as the lowest boiling point of the plural raw material compounds which make the mixture, or a decreased boiling point if the boiling point is decreased by making an azeotropic mixture. In addition, when the copolymer or the blend polymer is obtained form the mixture, the glass transition temperature of the copolymer or the blend polymer is defined as Tg. Among them, (meth)acrylic acid ester or fluorine-containing polymer preferably forms the light transmission medium.

Concretely, examples of the (a) (meth) acrylic ester without fluorine are methyl methacrylate; ethyl methacrylate; isopropyl methacrylate; tert-butyl methacrylate; benzyl methacrylate; phenyl methacrylate; cyclohexyl methacrylate, diphenylmethyl methacrylate; tricyclo[5•2•1•0^{2.6}]decanyl methacrylate; adamanthyl methacrylate; isobornyl methacrylate; norbornyl methacrylate; methyl acrylate; ethyl acrylate; tert-butyl acrylate; phenyl acrylate, and the like.

Examples of (b) (meth)acrylic ester with fluorine are 2,2,2-trifluoroethyl methacrylate; 2,2,3,3-tetrafluoro propyl methacrylate; 2,2,3,3,3-pentafluoro propyl methacrylate; 1-trifluoromethyl-2,2,2-trifluoroethyl methacrylate; 2,2,3,3,4,4,5,5-octafluoropenthyl methacrylate; 2,2,3,3,4,4,-hexafluorobutyl methacrylate, and the like.

Further, in (c) styrenetype compounds, there are styrene; α-methylstyrene; chlorostyrene; bromostyrene and the like. In (d) vinylesters, there are vinylacetate; vinylbenzoate; vinylphenylacetate; vinylchloroacetate; and the like. Although the present invention is not limited to the above kinds of the polymerizable compounds, it is preferable that the kinds and relative proportions of the polymerizable compounds are selected such that the homopolymer or the copolymer from the polymerizable compounds has a desired refractive index distribution in the light transmission medium formed therefrom.

As to the preferred polymer for forming the outer clad, besides the above-mentioned various compounds, there is copolymer of methylmethacrylate (MMA) and fluoro(meth)acrylate, for example. As fluoro(meth)acrylate, there are trifluoroethyl methacrylate (FMA), hexafluoro isopropyl methacrylate and so forth, for example. Moreover, there is copolymer of MMA and alicyclic (meth)acrylate. As alicyclic (meth)acrylate, there are (meth)acrylate having branch such as tert-butyl methacrylate, isobonyl methacrylate, norbonyl methacrylate, tricyclodecanyl methacrylate and so forth. Further, it is possible to use polycarbonate (PC), norbornene-based resin (for example, ZEONEX (registered trademark: produced by ZEON corporation)), functional norbornene-based resin (for example, ARTON (registered trademark: produced by JSR)), fluororesin (for example, polytetrafluoroethylene (PTFE), polyvinylidene fluoride (PVDF) and so forth). Furthermore, it is possible to use copolymer of fluorine resin (for example, PVDF-based copolymer), tetrafluoroethylene, perfluoro alkylvinyl ether (PFA) random copolymer, chlorotrifluoroethylene (CTFE) copolymer, and so forth.

When the polymer for the preform includes hydrogen atom (H), it is preferable to substitute deuterium atom (D) for the hydrogen atom. By virtue of this, transmission loss may be reduced. Especially, the transmission loss may be reduced relative to wavelengths of a near-infrared region.

In order to use the POF 21 for the near-infrared rays, polymers such as described in Japanese Patent No. 3332922 and Japanese Patent Laid-Open Publication No. 2003-192708 are utilized. In this polymer, deuterium atom, fluorine and so forth are substituted for the hydrogen atom of a C—H bond, since absorption loss is caused by the C—H bond. By using this kind of the polymer, the wavelength region causing the transmission loss is shifted to the longer-wavelength side, and it is possible to reduce the loss of the transmission signal light. With respect to this kind of the polymer, for instance, there are deuteriated polymethylmethacrylate (PMMA-d8), polytrifluoroethylmethacrylate (P3FMA), and polyhexafluoro isopropyl-2-fluoroacrylate (HFIP2-FA). Incidentally, it is desirable that the impurities and foreign materials in the raw compound that causes dispersion should be sufficiently removed before polymerization so as to keep the transparency of the POF after polymerization.

Weight-average molecular weight of the polymer for forming the preform 11 is preferable to be from ten thousands to one million, in consideration of suitable drawing of the preform 11. Much preferably, the weight-average molecular weight is from thirty thousands to a half of one million. Drawing properties concern molecular weight distribution (MWD: weight-average molecular weight/number average molecular weight) as well. In a case that the MWD is too large, the drawing properties deteriorate when a constituent having extremely large molecular weight is mixed. In this case, sometimes it becomes impossible to perform drawing. The range of the preferred MWD is four or less, and much preferably is three or less.

When the polymerizable compound is polymerized to produce a polymer, polymerization initiators are sometimes used. As to the polymerization initiators, there are various kinds to produce radicals. For example, there are benzoil peroxide (BPO); and peroxide compound [such as tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like]. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylpropane); 2,2′-azobis(2-methylbutane)2,2′-azobis(2-methylpentane); 2,2′-azobis(2,3-dimethylbutane); 2,2′-azobis(2-methylhexane); 2,2′-azobis(2,4-dimethylpentane); 2,2′-azobis (2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate), and the like. Note that the polymerization initiators are not limited to the above substances. More than one kind of the polymerization initiators may be combined.

In order to keep the physical properties, such as mechanical properties, thermal properties and so forth of the polymer, over the whole plastic optical fiber to be manufactured, it is preferable to control the polymerization degree by use of the chain transfer agent. The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY & SON). In addition, the chain transfer coefficient may be calculated through the experiments in the method described in “Experiment Method of Polymers” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophenol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom on C—H bond may be substituted by the fluorine atom (F) or a deuterium atom (D) in the chain transfer agent. Note that the chain transfer agents are not limited to the above substances. More than one kind of the chain transfer agents may be combined.

The dopant is a compound that has different refractive index from the polymerizable compound to be combined. The difference in the refractive indices between the dopant and the polymerizable monomer is preferably 0.005 or larger. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or larger. Any materials having such features may be used as the dopant if such material can stably exist with the polymers, and the material is stable under the polymerizing condition (such as heat and pressure conditions) of the polymerizable monomers as described above.

The dopant may be polymerizable compound, and in that case, it is preferable that the copolymer having the dopant as the copolymerized component increases the refractive index in comparison of the polymer without the dopant. Any materials having such features may be used as the dopant if such material can change the refractive index and stably exists with the polymers, and the material is stable under the polymerizing condition (such as temperature and pressure conditions) of the polymerizable compound which is the core monomer or the raw material of the inner clad. This embodiment shows the method to form refractive index profile in the core by mixing the dopant with the polymerizable compound for the core, by controlling the direction of polymerization according to the interface gel polymerizing method, and by providing gradation in concentration of the refractive index control agent as the dopant during the process to form the core. In addition, there are other methods, one example is a method in which the refractive index control agent is diffused in the formerly-formed preform. Hereinafter, the core having the refractive index profile will be referred to as “graded index core”. Such graded index core realizes the graded index type plastic optical member having wide range of transmission band.

Examples of the dopants are benzyl benzoate (BEN); diphenyl sulfide (DPS); triphenyl phosphate (TPP); benzyl n-butyl phthalate (BBP); diphenyl phthalate (DPP); diphenyl (DB); diphenylmethane (DPM); tricresyl phosphate (TCP); diphenylsulfoxide (DPSO). Among them, BEN, DPS, TPP and DPSO are preferable. In addition, the dopant may be the polymerizable compound such as tribromo phenylmethacrylate. In this case, there may be advantageous in heat resistance although it would be difficult to control various properties (especially optical property) because of copolymerization of the polymerizable monomer and the polymerizable dopant for forming a matrix. It is possible to alter the refractive index of the POF 21 to a desired value by controlling the concentration and the distribution of the dopant to be mixed in the core 13.

With respect to adding quantity of the polymerization initiator, the chain transfer agent, and the dopant, it is possible to properly determine a preferable range in accordance with the kind and so forth of the core monomer. In this embodiment, the polymerization initiator is added so as to be 0.005 to 0.050 mass % relative to the core monomer. It is much preferable to set this additive rate within a range of 0.010 to 0.020 mass %. Meanwhile, the chain transfer agent is added so as to be 0.10 to 0.40 mass % relative to the core monomer. It is much preferable to set this additive rate within a range of 0.15 to 0.30 mass %. In addition, when the dopant is added, its additive rate is preferably set in a range of 1 to 50 mass % relative to the core monomer.

Other additives may be contained in the core and the clad so far as the transmittance properties do not decrease. For example, the additives may be used for increasing resistance of climate and durability. Further, induced emissive functional compounds may be added for amplifying the optical signal. When such compounds are added to the monomer, attenuated signal light is amplified by excitation light so that the transmission distance increases. Therefore, the optical member with such additive may be used as an optical fiber amplifier in an optical transmission link. These additives may be contained in the core, the clad and a part thereof by polymerizing the additives with the various polymerizable compounds being as the raw material.

One of production methods for the preform of the GI type is described in Japanese Patent No. 3332922. In this method, a cylindrical resin pipe to be a clad is formed, a resin compound to be a core is poured into the hollow portion of the cylindrical pipe, and then the interface gel polymerization, which is one of the bulk polymerization, is performed to form the core. Although the polymerization conditions such as the polymerization temperature and the polymerization period are different according to kind and so forth of monomer and polymerization initiator, the general preferable conditions are as follows: the polymerization temperature is at least 60° C. and no more than the glass transition point of the generated polymer, more preferably in a range of 60° C. to 150° C.; and the polymerization period is in a range of 5 hours to 72 hours, more preferably in a range of 5 hours to 48 hours. The polymerization reaction preferably performed in the inert gas atmosphere, and increasing or reducing pressure may be applied at that time if needed. In addition, there are polymerization conditions described in WO 03/19252, to form a core with no concentration fluctuation. The core may be formed by another known method, in which plural kinds of polymerizable compounds are sequentially applied to form layers having different refractive indices. Note that the production method for the preform of the GI type is not limited to the interface gel polymerization described above. As the resin compound, there are a resin compound having single refractive index in which a refractive index control agent is applied, a mixture of plural resins having different refractive indices, a copolymer and so forth. The present invention can be applied to various types of the POF having various refractive index profiles such as a single mode type and a step index type, in addition to the GI type.

The POF is normally coated with at least one protective layer, for the purpose of improving flexural and weather resistance, preventing decrease in property by moisture absorption, improving tensile strength, providing resistance to stamping, proving resistance to flame, protecting from damage by chemical agents, noise prevention from external light, increasing the value by coloring, and the like.

Examples of the material for the protective layer are as follows. These are effective in providing mechanical property (such as bending property) due to high elasticity. There are rubbers as the polymer, such as isoprene rubbers (for example, natural rubber and isoprene rubber), butadiene rubbers (for example, styrene-butadiene copolymer rubber and butadiene rubber), diene special rubbers (for example, nitrile rubber and chloroprene rubber), olefin rubbers (for example, ethylene-propylene rubber, acrylic rubber, butyl rubber and halide butyl rubber), ether rubbers, polysulfide rubbers and urethane rubbers.

The material for the protective layer may be a liquid rubber that exhibits fluidity in a room temperature and becomes solidified by application of heat. Examples of the liquid rubber are polydiene rubbers (basic structure is polyisoprene, polybutadiene, butadiene-acrylonitril copolymer, polychloroprene, and so forth), polyorefin rubbers (basic structure is polyorefin, polyisobutylene, and so forth), polyether rubbers (basic structure is poly(oxypropylene), and so forth), polysulfide rubbers (basic structure is poly(oxyalkylene disufide), and so forth) and polysiloxane rubbers (basic structure is poly(dimethyl siloxane), and so forth).

As for the material of the protective layer, thermoplastic elastomer (TPE) can be used as well. The thermoplastic elastomer exhibits rubber elasticity at a room temperature, and becomes plasticized at a high temperature so that the thermoplastic elastomer is appropriate for easy molding. Examples of the thermoplastic elastomer are styrene thermoplastic elastomers, olefin thermoplastic elastomers, vinyl chloride thermoplastic elastomers, urethane thermoplastic elastomers, ester thermoplastic elastomers, amide thermoplastic elastomers, and so forth. Other materials than those described above can be used as long as the coating layer is formed at a temperature of equal to or less than the glass transition temperature Tg (° C.) of the POF polymer. For example, it is possible to use copolymer and mixed polymer of the above described materials or other materials.

As for the material of the protective layer, the material obtained by thermal hardening of the mixed liquid of a polymer precursors and reaction agent is preferably used. An example of such material is one-component thermosetting urethane composition produced from NCO block prepolymer and powder-coated amine, as described in JP-A No. 10-158353. Another example is one-component thermosetting urethane composition that is composed of urethane pre-polymer with NCO group, described in WO 95/26374, and solid amine having the size of 20 μm or smaller. For the purpose of improving the properties of the primary protective layer, additives and fillers may be added. Examples of the additives are incombustibility, antioxidant, radical trapping agent, lubricant. The fillers may be made from organic and/or inorganic compound.

The POF may have a second (or more) protective layer around the above described protective layer as the first protective layer. If the first protective layer has a thickness enough to decrease the thermal damage to the POF, the requirement of the hardening temperature of the second protective layer becomes less strict compared with the first protective layer. The second protective layer may be provided with the additives such as fire retardants, UV absorbent, antioxidant, radical trapping agent, shading agent and lubricant. The flame retardants are a resin and an additive with halogen like bromine or with phosphorus. Metal hydroxide is preferably used as the flame retardant for the purpose of reducing toxic gas emission. The metal hydroxide contains water of crystallization, which is not removed during the manufacture of the POF. Thus, it is preferable to provide a moisture proof coat around the first protective layer and to form the metal hydroxide as the flame retardant around the moisture proof coat.

The POF may be coated with plural coat layers with multiple functions. Examples of such coat layers are the flame retardant layer described above, a barrier layer to prevent moisture absorption, moisture absorbent (moisture absorption tape or gel, for instance) between the protective layers or in the protective layer, a flexible material layer and a styrene forming layer as shock absorbers to relax stress in bending the POF, a reinforced layer to increase rigidity. The thermoplastic resin as the coat layer may contain structural materials to increase the strength of the optical fiber cable. The structural materials are a tensile strength fiber with high elasticity and/or a metal wire with high rigidity. Examples of the tensile strength fibers are an aramid fiber, a polyester fiber, a polyamide fiber. Examples of the metal wires are stainless wire, a zinc alloy wire, a copper wire. The structural materials are not limited to those listed above. It is also possible to provide other materials such as a metal pipe for protection, a support wire to hold the optical fiber cable. A mechanism to increase working efficiency in wiring the optical fiber cable is also applicable.

The POF manufactured by the present invention is suitable for a plastic optical cable. In accordance with the way of use, the POF is selectively used as a cable assembly in which the POFs are circularly arranged, a tape core wire in which the POFs are linearly aligned, a cable assembly in which the tape core wires are bundled by using a band or LAP sheath, or the like.

When an optical device containing the POF according to the present invention is used, it is preferable to ensure to fix the terminal of the optical device by using an optical connector. The optical connectors widely available on the market are PN type, SMA type, SMI type, F05 type, MU type, FC type, SC type and the like.

The POF of the present invention can be used with various kinds of light emitting elements. Preferable one is Vertical Cavity Surface-Emitting Laser (VCSEL) described in Japanese Patent Laid-Open Publications No. 7-307525, No. 10-242558, No. 2003-152284, which has a narrow divergence angle and a high accumulation ratio, is actuated by relatively low-current, and can change a laser emission wavelength according to an elemental ratio. In addition, the present invention can be applied to a system to transmit optical signals, which uses optical signal processing devices including optical components, such as a light receiving element, an optical switch, an optical isolator, an optical integrated circuit, an optical transmitter and receiver module, and the like. Any known techniques can be applied to such system. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to short-distance optical transmission system that is suitable for high-speed and large capacity data communication and for control under no influence of electromagnetic wave. Concretely, the optical member is applicable to wiring in apparatuses (such as computers and several digital apparatuses), wiring in trains and vessels, optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet Bath’ in Journal of Japan Institute of Electronics Packaging., Vol. 3, No. 6, 2000, pp. 476-480”. Moreover, there are an arrangement of light emitting elements on a waveguide surface (disclosed in Japanese Patent Laid-Open Publication No. 2003-152284), an optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-241655); an optical signal transmission device and an optical data bus system (disclosed in Japanese Patent Laid-Open Publications No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The optical member according to the present invention is also applicable to other purposes, such as for lighting, energy transmission, illumination, and sensors.

The present invention will be described in detail with reference to Experiments (1)-(3) as the embodiments of the present invention and Comparative experiments (1)-(3) as the comparisons. The description below explains Experiment (1) in detail. Regarding Experiments (2)-(3) and Comparative experiments (1)-(3), the portions different from Experiment (1) will be explained.

### Experiment (1)

By the melt-extrusion molding, the pipe 23 of PVDF to be the outer clad 16 was formed. The pipe 23 has the outer diameter of 20 mm, the thickness t1 of 0.5 mm, and the length of 905 mm. The clad pipe 23 was inserted in the rigid polymerization container 62. The pipe 23 was washed with pure water, and was dried under the temperature of 90° C. Thereafter, one end of the pipe 23 was sealed sealed with the plug 61 of KF-850 pellet (manufactured by KUREHA CORPORATION). Then the pipe 23 was subject to the heating under reduced pressure. In this process, a commercial vacuum dryer used needs to be able to reduce the inside pressure at least 1 Pa from the atmospheric pressure. In Experiment 1, the conditions of the heating under reduced pressure were a temperature of 40° C., a pressure of −50 Pa (from the atmospheric pressure), and a period of 15 hours.

Next, the inner clad 15 was formed. A mixed liquid was made by adding the polymerization initiator and the chain transfer agent into deuteriated methylmethacrylate (MMA-d8) as the inner clad monomer in following concentrations. The amount of dimethyl-2,2′-azobis(2-methylpropionate) (V-601) as the polymerization initiator was 0.012 mol % of the inner clad monomer, and the amount of n-laurylmercaptan as the chain transfer agent was 0.2 mol % of the inner clad monomer. 200 g of the mixed liquid was poured into the pipe 23.

After substituting the air in the tip of the pipe 23 with argon gas, the other end of the pipe 23 was tightly sealed with the plug 61 of silicon and a sealing tape. Then the pipe 23 containing the inner clad liquid was inserted in the polymerization container 62, and the polymerization container 62 was set in the rotation polymerization device 71 and horizontally rotated to form the inner clad 15 on the inner surface of the pipe 23 by polymerizing the inner clad liquid. The rotation polymerization was performed in two stages. At the first stage, the polymerization temperature was 60° C. and the reaction time was 18 hours. At the second stage, the polymerization temperature was 90° C. and the polymerization period was 4 hours. The rotation speed was 500 rpm to 3000 rpm at both of the first and second stages.

Then the pipe 23 in which the inner clad 15 was formed was subject to the heating under reduced pressure. In this process, a commercial vacuum dryer used needs to be able to reduce the inside pressure at least 1 Pa from the atmospheric pressure. In Experiment 1, the conditions of the heating under reduced pressure were a temperature of 40° C., a pressure of −50 Pa (from the atmospheric pressure), and a treatment time of 15 hours.

Next, the core 12 was formed. A mixed liquid was made by adding the polymerization initiator, the chain transfer agent and the dopant into all-deuteriated methylmethacrylate (MMA-d8) as the core monomer in following concentrations. The amount of dimethyl-2,2′-azobis(2-methylpropionate) (V-601) as the polymerization initiator was 0.04 mol % of the core monomer, the amount of n-laurylmercaptan as the chain transfer agent was 0.2 mol % of the core monomer, and the amount of diphenyl sulfide (DPS) as the dopant was 7 wt. % of the core monomer. 100 g of the mixed liquid was poured into the hollow portion of the clad 13.

Then the clad 13 containing the core liquid was inserted in the polymerization container 62, and the polymerization container 62 was set in the rotation polymerization device 71 and horizontally rotated to form the core 12 on the inner surface of the clad 13 by polymerizing the core liquid. The rotation polymerization was performed in three stages. At the first stage, the polymerization temperature was 70° C. and the polymerization period was 5 hours. At the second stage, the polymerization temperature was 90° C. and the polymerization period was 5 hours. At the third stage, the polymerization temperature was 120° C. and the polymerization period was 24 hours. The rotation speed was 500 rpm to 2000 rpm at all of the first to third stages. The obtained preform 11 had a hollow portion in the center of the cross section. In the preform 11, a rate of content of the inner clad monomer and its polymer in the outer clad was 1.6 wt. %. The rate of content was obtained by peeling the outer clad from the inner clad before the polymerization reaction for the core, dissolving the peeled outer clad in N,N-Dimethylformamide (DMF) and measuring an amount of the MMA in the solution with use of a gas chromatography (GC-1700 of SHIMADZU CORPORATION).

The POF 21 was produced by drawing the preform 11 with use of the drawing apparatus 120 shown in FIG. 11.

The heating furnace 140 is a cylindrical shape having 380 mm height and 80 mm inner diameter, and comprises plural heating areas along the drawing direction of the preform 11, each of which has a different heating temperature. The temperatures of the heating areas were set at 230° C. to 45° C., gently from the upstream side to the downstream side of the heating furnace 140, with respect to the drawing direction of the preform 11. The drawing speed was 15 m/min, and the pressure in the hollow portion of the preform 11 was (atmospheric pressure −5) kPa. Accordingly, the POF 21, having 316 μm outer diameter with no hollow portion, was obtained.

A sample of 3 m length of the POF 21 was taken for searching a change of the outer diameter in a period of at least 0.5 m. And the transmission loss of the sample at the wavelength of 650 nm was measured. As a result, the change of the outer diameter was no more than ±10 μm, and the transmission loss was 75 dB/km.

### Experiment (2)

In Experiment (2), the heating temperature in the heating under reduced pressure 25 was 90° C. Other conditions were the same as those in Experiment (1).

In the preform 11, a rate of content of the inner clad monomer and its polymer in the outer clad was 0.3 wt. %. In the POF 21, a change of the outer diameter was no more than ±6 μm, and a transmission loss was 70 dB/km.

### Experiment (3)

In Experiment (3), the heating temperature in the heating under reduced pressure 25 was 130° C. Other conditions were the same as those in Experiment (1).

In the preform 11, a rate of content of the inner clad monomer and its polymer in the outer clad was 0.1 wt. %. In the POF 21, a change of the outer diameter was no more than ±5 μm, and a transmission loss was 67 dB/km.

### Comparative Experiment (1)

In Comparative experiment (1), the heating under reduced pressure 25 was not applied to the outer clad pipe 23. Other conditions were the same as those in Experiment (1).

In the preform 11, a rate of content of the inner clad monomer and its polymer in the outer clad was at least 2 wt. %. In the POF 21, a change of the outer diameter was no more than ±30 μm, and a transmission loss was 100 dB/km.

### Comparative Experiment (2)

In Comparative experiment (2), the heating temperature in the heating under reduced pressure 25 was 30° C. Other conditions were the same as those in Experiment (1).

In the preform 11, a rate of content of the inner clad monomer and its polymer in the outer clad was 1.8 wt. %. In the POF 21, a change of the outer diameter was no more than ±15 μm, and a transmission loss was 90 dB/km.

### Comparative Experiment (3)

In Comparative experiment (3), the heating temperature in the heating under reduced pressure 25 was 140° C. Other conditions were the same as those in Experiment (1).

In Comparative experiment (3), the obtained preform 11 was not able to be drawn because it had a deformation including a warpage.

According to Experiments (1)-(3) and Comparative experiments (1)-(3), it was found that the present invention can inhibit the penetration of the inner clad material into the outer clad, and therefore the unevenness viscosity of the melted preform for the drawing is reduced. In addition, it was also found that the present invention can improve the transmission property of the POF by reducing the periodical change of the outer diameter of the POF.

Various changes and modifications are possible in the present invention and may be understood to be within the present invention.

### INDUSTRIAL APPLICABILITY

The present invention is preferably applied to a plastic optical fiber for optical transmission, lighting, energy transmission, illumination, sensor and so forth.

1. A production method for a plastic optical fiber preform comprising steps of:
forming a cylindrical member;
polymerizing a polymerizable compound in a hollow portion of said cylindrical member to form an inner member of polymer on an inner wall of said cylindrical member, said polymerization being bulk polymerization in which said polymerizable compound penetrates into said inner wall to generate and proceed polymerization reaction; and
controlling a concentration of said polymerizable compound and said polymer penetrated in said cylindrical member to a predetermined value.

2. A production method for a plastic optical fiber preform described in claim 1, a refractive index of said cylindrical member being no more than that of said polymer, and said concentration being no more than 1.6 wt. %.

3. A production method for a plastic optical fiber preform described in claim 1, wherein said controlling step is performed while and/or after said polymerization reaction, by heating said cylindrical member in a reduced pressure.

4. A production method for a plastic optical fiber preform described in claim 3, wherein said heating is performed in a temperature range of 40° C. to 130° C.

5. A production method for a plastic optical fiber preform described in claim 1, wherein said plastic optical fiber preform is a graded index plastic optical fiber preform, whose refractive index increases toward the center in the cross section.

6. A plastic optical fiber preform comprising:
a cylindrical member; and
an inner member formed on an inner wall of said cylindrical member, said inner member being a polymer formed by bulk polymerization of polymerizable compound in a hollow portion of said cylindrical member, and a concentration of said polymerizable compound and said polymer penetrated in said cylindrical member being determined to a predetermined value.

7. A plastic optical fiber preform described in claim 6, a refractive index of said cylindrical member being no more than that of said polymer, and said concentration being no more than 1.6 wt. %.

8. A plastic optical fiber preform described in claim 6, wherein said polymerizable compound is (meth)acrylic acid ester and said cylindrical member is fluorine compound.

9. A plastic optical fiber preform described in claim 6, wherein said plastic optical fiber preform has a refractive index increases toward the center in the cross section.

10. A plastic optical fiber produced by drawing said plastic optical fiber preform described in claim 6 in its longitudinal direction.
